(19) United States
(12) Patent Application Publication
(10) Pub. No.: US 2025/0225427 A1
(43) Pub. Date: Jul. 10, 2025

(54) SYSTEMS AND METHODS FOR LEARNING SYSTEM APPROACH TO ARTIFICIAL INTELLIGENCE MODELS

(71) Applicant: JPMORGAN CHASE BANK, N.A., New York, NY (US)

(72) Inventors: Najah GHALYAN, Wayne, NJ (US); Sean MORAN, London (GB); Drew CUKOR, New York, NY (US)

(21) Appl. No.: 18/405,691

(22) Filed: Jan. 5, 2024

(51) Int. Cl. G06N 20/00; G06N 5/022

(52) U.S. Cl. CPC G06N 20/00; G06N 5/022

(57) ABSTRACT

Systems and methods for learning system approach to artificial intelligence models are disclosed. A method may include: (1) receiving, by a computer program executed by an electronic device, a current artificial intelligence (AI) model; (2) providing, by the computer program, input data from a plant to the current AI model; (3) receiving, by the computer program, current AI model predictions from the current AI model; (4) receiving, by the computer program and from subject matter expert electronic device, feedback-based labels for the current AI model predictions; (5) determining, by the computer program, a prediction error between the current AI model predictions and the feedback-based label; and (6) applying, by the computer program, a model reference adaptive control algorithm to the current AI model in response to the prediction error being greater than a threshold.

### BACKGROUND OF THE INVENTION

### 1. Field of the Invention

Embodiments relate to systems and methods for learning system approach to artificial intelligence models.

### 2. Description of the Related Art

In general, an artificial intelligence (AI) model starts with a proof of concept (PoC) phase in which the model is developed, trained, and validated. Next is the minimum viable product (MVP) phase in which the AI model is provided with live data and the performance is tested at scale. If successful, the AI model moves to the pilot phase, where it is provided in a pre-production pipeline for testing before deployment. Finally, if the pilot phase is successful, in the operational or production phase, the AI model is deployed to a production environment, where it provides its output to client systems.

With this process, however, there can be issues. For example, a quality labeled dataset is often not available for training and validating AI models. And, after an AI model is developed and validated on a dataset, it may significantly degrade when deployed to the production environment for many reasons, including data and concept drift over time.

### SUMMARY OF THE INVENTION

Systems and methods for learning system approach to artificial intelligence models are disclosed. According to an embodiment, a method for anomaly detection in software-defined networks from observed host metrics may include: (1) receiving, by a computer program executed by an electronic device, a current artificial intelligence (AI) model; (2) providing, by the computer program, input data from a plant to the current AI model; (3) receiving, by the computer program, current AI model predictions from the current AI model; (4) receiving, by the computer program and from a subject matter expert electronic device, feedback-based labels for the current AI model predictions; (5) determining, by the computer program, a prediction error between the current AI model predictions and the feedback-based label; (6) generating, by the computer program, an updated training dataset in response to the prediction error being greater than a threshold; (7) training, by the computer program, the current AI model with the updated training dataset, resulting in a new AI model; (8) providing, by the computer program, the new AI model and the current AI model with an updated test dataset; (9) receiving, by the computer program, new AI model predictions from the new AI model and current AI model predictions from the current AI model; (10) selecting, by the computer program, the new AI model or the current AI model based on the new AI model predictions and the current AI model predictions; and (11) deploying, by the computer program, the new AI model or the current AI model based on the selection.

In one embodiment, the step of selecting, by the computer program, the new AI model or the current AI model based on the new AI model predictions and the current AI model predictions may include: determining, by the computer program, a new AI model performance for the new AI model and a current AI model performance for the current AI model; and determining, by the computer program, a performance difference between the new AI model performance and the current AI model performance; wherein the new AI model may be selected in response to the performance difference being greater than a performance threshold.

In one embodiment, the new AI model performance and the current AI model performance may be measured using at least one of accuracy, an area under receiver operating curve, and a F1-score.

In one embodiment, the performance threshold may be based on a cost to replace the current AI model.

In one embodiment, the feedback-based labels for the current AI model predictions may be received as a correct prediction or an incorrect prediction.

In one embodiment, the prediction error may be based on a number of predictions that received a correct prediction feedback, and a number of predictions that receive an incorrect prediction feedback.

In one embodiment, the updated training dataset may include the training dataset with the feedback-based labels and a second labeled dataset.

In one embodiment, the step of deploying, by the computer program, the new AI model or the current AI model based on the selection may include: executing, by the computer program, a corrective action in response to the current AI model being selected.

In one embodiment, the corrective action may include: collecting, by the computer program, additional feedback; and retraining, by the computer program, the current AI model using the additional feedback.

According to another embodiment, a method may include: (1) receiving, by a computer program executed by an electronic device, a current artificial intelligence (AI) model; (2) providing, by the computer program, input data from a plant to the current AI model; (3) receiving, by the computer program, current AI model predictions from the current AI model; (4) receiving, by the computer program and from subject matter expert electronic device, feedback-based labels for the current AI model predictions; (5) determining, by the computer program, a prediction error between the current AI model predictions and the feedback-based label; and (6) applying, by the computer program, a model reference adaptive control algorithm to the current AI model in response to the prediction error being greater than a threshold.

In one embodiment, the feedback-based labels for the current AI model predictions may be received as a correct prediction or an incorrect prediction.

In one embodiment, the prediction error may be based on a number of predictions that received a correct prediction feedback, and a number of predictions that receive an incorrect prediction feedback.

In one embodiment, the model reference adaptive control algorithm may include at least one of a parameter adaptation algorithm, a model identification algorithm, an adaptive law algorithm, an adaptive gain scheduling algorithm, a robust control technique, and an online learning algorithm.

In one embodiment, the method may also include dynamically tuning, by the computer program, the current AI model after the application of the model reference adaptive control algorithm using one or more of reinforcement learning, an evolutionary algorithm, meta-learning, online learning, Bayesian optimization, transfer learning, adversarial training, and automated machine learning.

According to another embodiment, a non-transitory computer readable storage medium, may include instructions stored thereon, which when read and executed by one or more computer processors, cause the one or more computer processors to perform steps comprising: receiving a current artificial intelligence (AI) model; providing input data from a plant to the current AI model; receiving current AI model predictions from the current AI model; receiving, from subject matter expert electronic device, feedback-based labels for the current AI model predictions; determining a prediction error between the current AI model predictions and the feedback-based label; generating an updated training dataset in response to the prediction error being greater than a threshold; training the current AI model with the updated training dataset, resulting in a new AI model; providing the new AI model and the current AI model with an updated test dataset; receiving new AI model predictions from the new AI model and current AI model predictions from the current AI model; selecting the new AI model or the current AI model based on the new AI model predictions and the current AI model predictions; and deploying the new AI model or the current AI model based on the selection.

In one embodiment, the new AI model or the current AI model may be selected by: determining a new AI model performance for the new AI model and a current AI model performance for the current AI model; and determining a performance difference between the new AI model performance and the current AI model performance; wherein the new AI model may be selected in response to the performance difference being greater than a performance threshold.

In one embodiment, the new AI model performance and the current AI model performance may be measured using at least one of accuracy, an area under receiver operating curve, and a F1-score, and the performance threshold may be based on a cost to replace the current AI model.

In one embodiment, the feedback-based labels for the current AI model predictions may be received as a correct prediction or an incorrect prediction, and the prediction error may be based on a number of predictions that received a correct prediction feedback, and a number of predictions that receive an incorrect prediction feedback.

In one embodiment, the updated training dataset may include the training dataset with the feedback-based labels and a second labeled dataset.

In one embodiment, the non-transitory computer readable storage may also include instructions stored thereon, which when read and executed by one or more computer processors, cause the one or more computer processors to execute a corrective action in response to the current AI model being selected by: collecting additional feedback; and retraining the current AI model using the additional feedback.

### BRIEF DESCRIPTION OF THE DRAWINGS

For a more complete understanding of the present invention, the objects and advantages thereof, reference is now made to the following descriptions taken in connection with the accompanying drawings in which:

FIG. 1 illustrates a system for learning system approach to artificial intelligence models according to an embodiment;

FIGS. 2A and 2B illustrate a method for learning system approach to artificial intelligence models according to an embodiment;

FIG. 3 illustrates a method for learning system approach using model reference adaptive control according to an embodiment; and

FIG. 4 depicts an exemplary computing system for implementing aspects of the present disclosure.

### DETAILED DESCRIPTION OF PREFERRED EMBODIMENTS

Embodiments relate to systems and methods for learning system approach to artificial intelligence models.

Embodiments may use a Learning Systems Approach (LSA) aimed at enabling implementing and productionizing an adaptively tuned model driven by feedback, such as labels, provided by Subject Matter Experts (SMEs) during the MVP and Production phases. Embodiments use the SMEs feedback to tune/retrain the model to reduce discrepancies between the model's output and ground truth labels provided by SMEs corrections.

Embodiments may use a LSA with the MVP to provide a criterion for passing a model to the production phase based on the performance of adaptively tuned/retrained model version that was originally tuned/retrained on a limited dataset during the proof of concept phase.

Embodiments may use a plurality of different algorithms for implementing LSA in the production phase. For example, with a first algorithm (e.g., a Threshold-Based LSA), a model's retraining/tuning is triggered once a sufficient number of SME labels are provided and there is a discrepancy between model's predictions and labels provided by SMEs. The discrepancy may be based on a configurable threshold.

A second algorithm (e.g., a model reference adaptive control (MRAC)-based LSA) may tune the model using, for example, MRAC methodology. This may be driven by deviation of model's output from SME feedback-based labels generated during operational phase of the model.

MRAC is a control method used in engineering to regulate a system's behavior by comparing its output to a desired reference model. It adjusts the controller parameters dynamically to match the behavior of the reference model, even if the system changes or has uncertainties. MRAC is particularly useful in situations where the exact model of the system might not be known or might change over time. By continuously adapting, it aims to keep the system's behavior close to the desired reference model.

Embodiments may use the MRAC method in the realm of AI and machine learning for continuous tuning and retraining of models. It can help adjust the parameters or structures of AI models dynamically in response to changing data distributions, concept drift, or evolving requirements. By using adaptive control techniques inspired by MRAC, AI models can adapt and improve their performance over time without requiring frequent manual intervention. This approach may be valuable in scenarios where the environment or the data the model interacts with is constantly changing.

Techniques commonly used in implementing MRAC may include, for example, parameter adaptation, model identification, adaptive laws, adaptive gain scheduling, robust control techniques, online learning algorithms, etc.

Parameter adaptation may involve adjusting the parameters of the controller based on the error signal between the system output and the reference model output. Techniques like gradient descent, recursive least squares (RLS), or stochastic approximation methods can be employed to iteratively update these parameters.

Model identification may identify the model using, for example, least squares, recursive algorithms, or neural networks to estimate the dynamics of the system, allowing the adaptive controller to mimic the system's behavior.

Adaptive laws may govern how the parameters of the controller are updated. There are various adaptive laws used in MRAC, including the MIT rule, Lyapunov-based adaptation laws, and many others. These laws ensure stability and convergence of the control system.

Adaptive gain scheduling may adjust controller gains or parameters based on specific conditions or operating points rather than directly adapting parameters. This may be particularly useful when the system exhibits significant changes in behavior under varying conditions.

Robust control technique may be incorporated with MRAC to enhance performance and stability. Techniques like robust adaptive control or sliding mode control may help handle uncertainties or disturbances that might affect the system.

Online learning algorithms, such as reinforcement learning or online gradient descent methods, may be used to continuously update and fine-tune the controller parameters based on real-time feedback from the system.

In embodiments, any of these techniques may be combined and tailored to suit the specific characteristics and requirements of the AI model being tuned. The goal is to generally design an MRAC-based algorithm for dynamically tuning the AI model so that it tracks a desired reference model despite uncertainties or variations in the plant's behavior. In embodiments, the desired reference model is represented by SMEs.

Adapting MRAC techniques to dynamically tune AI models may require a different approach than traditional control systems due to the nature of AI's learning process. Examples of how such techniques may be used are provide below.

1. Parameter Adaptation: In AI models, this can translate to updating the weights or parameters of the model based on the error between the predicted output and the desired output. Techniques like stochastic gradient descent (SGD), adaptive learning rates (e.g., Adam, RMSprop), or meta-learning algorithms can dynamically adjust these parameters.

2. Model Identification: AI models themselves can act as estimators of the system's behavior. For instance, recurrent neural networks (RNNs), long short-term memory networks (LSTMs), or transformers can adapt to changing patterns in sequential data, effectively identifying and modeling dynamic behaviors.

3. Adaptive Laws: Developing adaptive laws specific to AI involves defining rules for changing the learning rate, updating network architecture (e.g., adding or removing nodes or layers), adjusting regularization parameters, or modifying activation functions based on real-time feedback or changing data distributions.

4. Adaptive Gain Scheduling: This may involve changing the learning rate schedules or optimization strategies based on certain conditions. For instance, decreasing the learning rate if the error stagnates or increases may prevent divergence and improve convergence in training.

5. Robust Control Techniques: Incorporating robustness in AI models may involve using techniques like dropout, batch normalization, or regularization methods to handle variations in data distribution or noise. Techniques like adversarial training may also assist in making models robust against perturbations.

6. Online Learning Algorithms: Utilizing reinforcement learning (RL) or online gradient descent methods allows models to adapt and improve based on real-time interactions with the environment or changing data streams. RL agents, for example, continuously learn by exploring and exploiting new information.

Combining these techniques may involve a continuous monitoring and adjustment process during the AI model's training or inference. It may be necessary to define clear objectives, monitor performance metrics, and implement mechanisms to ensure that adaptation doesn't lead to instability or divergence in the model's behavior.

Embodiments may further dynamically tune AI models beyond using MRAC. Examples may include:

1. Reinforcement Learning (RL): RL enables an AI agent to learn optimal behavior by interacting with an environment. It continually adapts its actions based on received rewards, aiming to maximize cumulative reward. Techniques like Q-learning, policy gradients, and actor-critic methods fall under RL.

2. Evolutionary Algorithms: These algorithms use principles from biological evolution to optimize AI models. Genetic algorithms, genetic programming, and evolutionary strategies involve generating a population of models, evaluating their performance, and evolving them over successive generations.

3. Meta-Learning: Meta-learning focuses on enabling models to learn how to learn. It involves training models on various tasks to acquire a more generalized learning ability, enabling quicker adaptation to new tasks or environments.

4. Online Learning: This approach may involve continuously updating models as new data arrives. Online learning algorithms, such as online gradient descent, stochastic gradient descent, and incremental learning, allow models to learn from sequential data streams.

5. Bayesian Optimization: Bayesian methods use probabilistic models to optimize hyperparameters or architecture configurations. They efficiently explore the search space based on learned probabilities to find optimal configurations.

6. Transfer Learning: This may involve transferring knowledge from one task/domain to another. Pre-trained models or knowledge learned from similar tasks are utilized to expedite learning or adaptation in new, related tasks.

7. Adversarial Training: This method may involve training models against adversarial examples to improve robustness. Models are exposed to perturbed or adversarial data to make them more resistant to potential attacks or noise.

8. AutoML (Automated Machine Learning): AutoML techniques automate the process of model selection, hyperparameter tuning, and architecture search. They aim to find the best-performing model configurations automatically.

Each technique has its strengths and weaknesses, making them suitable for different scenarios. Depending on the problem domain, available data, computational resources, and the desired level of adaptation, one or a combination of these techniques may be used to dynamically tune AI models. Hybrid approaches that combine multiple methods may harness the advantages of different techniques.

The use of MRAC for dynamically tuning AI models may provide several technical advantages when compared to techniques like reinforcement learning when it comes to continuous adaptation and model improvement. Examples of such advantages may include:

1. Stability and Safety: MRAC techniques often ensure stability in control systems by design. When applied to AI models, they can maintain stability during continuous adaptation, reducing the risk of catastrophic changes or erratic behavior, which might be a concern in RL methods that explore and learn through trial and error.

2. Data Efficiency: MRAC can adapt to changing conditions without requiring large amounts of new data. RL methods, on the other hand, might need extensive exploration to learn optimal behavior, which can be data-intensive and inefficient in certain scenarios.

3. Controlled Adaptation: MRAC provides a more controlled approach to adaptation by directly adjusting model parameters based on a reference model. In contrast, RL methods might explore various actions, which can be suboptimal or even risky in critical applications.

4. Prior Knowledge Utilization: MRAC can leverage prior knowledge effectively. It allows for incorporating existing information about the system dynamics or task objectives into the adaptive process, whereas RL often starts with limited prior information and learns from scratch.

5. System Understanding: MRAC often involves understanding the system dynamics explicitly through a reference model. This understanding can help guide the adaptation process more directly compared to RL, which might require more extensive exploration to grasp the system dynamics.

6. Sample Efficiency: MRAC techniques can adapt using smaller amounts of data compared to some RL approaches that might require a significant number of interactions with the environment to learn effectively.

7. Mathematical rigor: Mathematical rigor is one of the important advantages that can be brought by MRAC. Even those most successful AI techniques like Large Language Models (LLMs), Reinforcement Learning (RL), Deep Learning (DL), etc., are mainly data-driven methods that generally lack mathematical rigor. Mathematical rigor be used in developing a model's tuning algorithm that can guarantee convergence of the AI model to mimic SMEs despite uncertainties and dynamic environment. Examples of key elements of the mathematical framework that contribute to these guarantees may include:

a. Lyapunov Stability Analysis: MRAC often employs Lyapunov stability theory, a mathematical tool used to analyze the stability of dynamical systems. It involves defining a Lyapunov function, typically a scalar function that measures the system's energy or a notion of proximity to a desired state. The decrease of this function over time ensures stability and convergence towards a desired equilibrium or reference model.

b. Adaptive Laws and Control Algorithms: The adaptive laws used in MRAC are formulated mathematically to adjust the controller parameters or model weights based on certain error signals or system behavior. These laws are designed such that they ensure boundedness or convergence of the adaptation process, ensuring stability over time.

c. Parameter Convergence Analysis: MRAC involves analyzing the convergence of the adaptive parameters. Mathematically proving the convergence of these parameters toward certain values under defined conditions guarantees that the control system converges to the desired behavior or reference model.

d. Robustness Analysis: MRAC techniques often include robust control principles, such as robust adaptive control or sliding mode control. These approaches incorporate mathematical methods to analyze and ensure stability even in the presence of uncertainties, disturbances, or variations in the system dynamics.

e. Frequency Domain Analysis: In some cases, MRAC employs frequency domain analysis, where the system's behavior is analyzed in terms of frequency response or transfer functions. This analysis allows for mathematical manipulation and design of controllers to ensure stability and convergence in specific frequency ranges.

These mathematical tools and analyses provide a rigorous framework to design and analyze adaptive control systems. They ensure that the adaptive process doesn't lead to instability, oscillations, or divergence from the desired behavior. The aim is to guarantee that the controlled system behaves according to a predefined reference model or objective despite uncertainties or variations.

The practical application of MRAC techniques, however, requires careful consideration of system assumptions, model accuracy, noise, and real-world complexities. Ensuring mathematical rigor often involves proving stability theorems, deriving convergence criteria, and verifying system behavior under various conditions to ensure the effectiveness of MRAC in real-world applications.

MRAC techniques offer a mathematical framework that provides guarantees regarding the convergence and stability of dynamically tuned AI models, given certain assumptions and conditions are met.

1. Stability Analysis: MRAC often relies on stability analysis techniques rooted in control theory, such as Lyapunov stability analysis. This mathematical framework allows for proving stability under specific conditions. It ensures that the adaptation process converges and doesn't lead to uncontrollable or divergent behaviors.

2. Convergence Guarantees: By formulating adaptive laws and control algorithms based on rigorous mathematical principles, MRAC aims to ensure convergence toward a desired reference model or optimal behavior. Mathematical proofs or analysis can demonstrate the convergence of the adaptive process under certain assumptions.

3. Robustness Analysis: Some MRAC techniques incorporate robust control methodologies, enabling models to handle uncertainties or disturbances in a principled manner. This robustness analysis provides guarantees that the adapted models remain stable even in the presence of disturbances or changes in the system.

4. Control Theoretic Framework: MRAC leverages mathematical frameworks from control theory, allowing for the application of well-established mathematical tools and techniques. This includes stability criteria, stability margins, frequency domain analysis, and other mathematical methods used to analyze and ensure the stability of control systems.

These guarantees, however, are often based on certain assumptions about the system's dynamics, the accuracy of the reference model, and the behavior of the adaptation process. Real-world complexities, such as noisy data, non-linearities, or modeling errors, might challenge these assumptions and impact the practical performance of MRAC-based techniques.

Therefore, while MRAC offers a robust mathematical foundation for stability and convergence analysis in dynamically tuned AI models, its effectiveness in ensuring these guarantees in real-world, complex systems may depend on the specific context and the degree to which underlying assumptions hold true.

Examples of automated adjustment mechanisms and elaborated descriptions of MRAC methods are disclosed in Ioannou, P., Sun, J. “Robust Adaptive Control” (2013), the disclosure of which is hereby incorporated, by reference, in its entirety.

Embodiments enable assessment of AI models not only based on the model's performance on a static set of data, but also based on the capability of the model to improve over time by adjusting to an dynamic environment and potential data and concept drift. Embodiments may also mitigate the lack of a quality labeled dataset for the model's development by starting with a reasonably developed model and enhancing that model over time by leveraging SME feedback-based labels generated during the operational phase of the model.

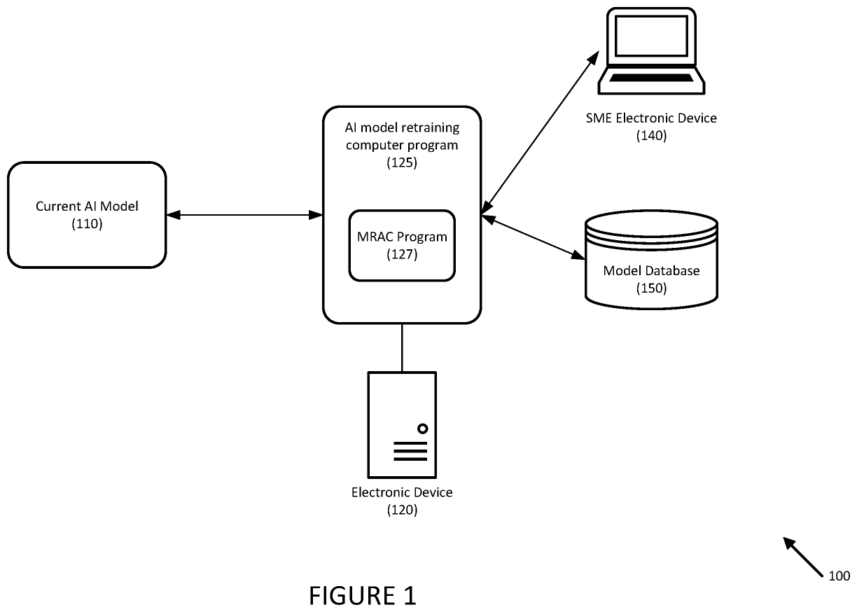

Referring to FIG. 1, a system for learning system approach to artificial intelligence models is disclosed according to an embodiment. System 100 may include current artificial intelligence (AI) model 110, electronic device 120 that may execute AI model retraining computer program 125, subject matter expert (SME) electronic device 140, and model database 150. Electronic device 120 and SME electronic device 140 may be any suitable electronic device, including servers (e.g., physical and/or cloud-based), computers (e.g., workstations, desktops, laptops, notebooks, tablets, etc.), smart devices, etc.

SMEs may provide labels, feedback, etc. to AI model retraining computer program 125 via SME electronic devices 140.

AI model retraining computer program may train current AI model 110 using, for example, model reference adaptive control (MRAC) program 127.

Model database 150 may store previous models that may be compared to current AI model 110.

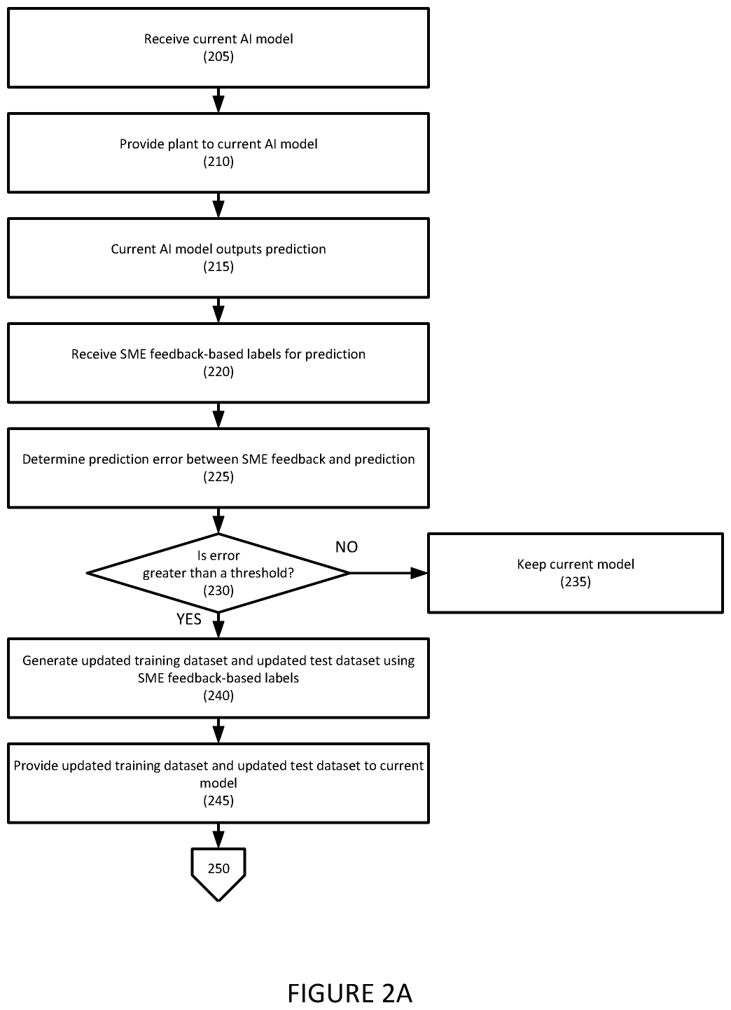

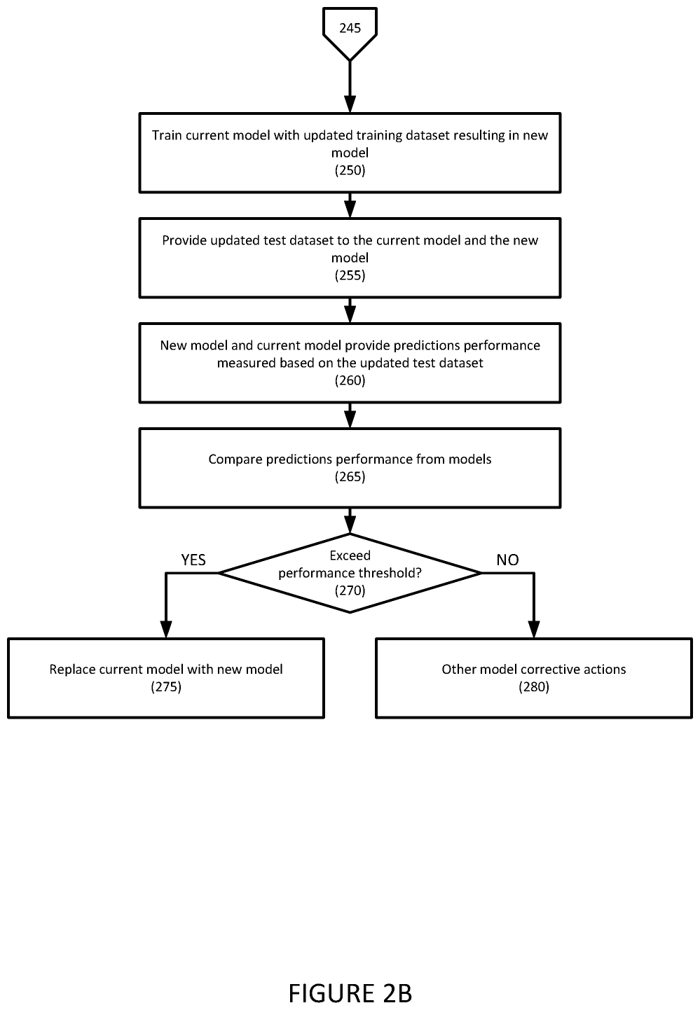

Referring to FIGS. 2A and 2B, a method for learning system approach to artificial intelligence models is disclosed according to an embodiment.

In step 205, a computer program, such as an AI model retraining computer program, may receive a current AI model. Examples of AI models are disclosed in U.S. patent application Ser. No. 18/405,498, entitled “Systems And Methods For Anomaly Detection In Software-Defined Networks From Observed Host Metrics,” filed concurrently herewith, the disclosure of which is hereby incorporated, by reference, in its entirety.

In one embodiment, the AI model may be in the MVP phase.

In step 210, the computer program may provide input data from a plant, such as a system to be monitored, to the current AI model, and in step 215, the current AI model may output its predictions.

In step 220, SMEs may provide feedback-based labels for the predictions. In one embodiment, the SMEs may provide a binary label (e.g., correct (1) or incorrect (0)). For multi-class classification and regression problems, the SMEs may provide more detailed feedback by providing their prediction for the plant.

In step 225, the computer program may determine a prediction error between the SME feedback and the current AI model's prediction. The error may represent a measure of the discrepancy between the model's predictions and ground-truth labels provided by SMEs. The error be calculated in different ways. For example, in a classification problem, the error may be based on the number of times the prediction and the SME label do not match divided by total number of predictions. For regression problems, the error may be the mean squared error (MSE). Other methods for calculating the error may be used as is necessary and/or desired.

In step 230, if the error is not greater than a threshold, in step 235, the current AI model may be kept.

If the error is greater than a threshold, in step 240, using the SME feedback-based labels, the computer program may generate an updated dataset including an updated training dataset and an updated test dataset. For example, the data input to the model and the SME labels may be added to a previous labeled dataset to get bigger and richer labeled dataset that can be used for model's retraining and testing.

In step 245, the computer program may provide the updated training dataset and updated test dataset to the current AI model, and in step 250, the current AI model may be retrained with the updated training dataset, resulting in a new AI model.

In step 255, the computer program may provide the updated test dataset to the current AI model (i.e., the model that has not been retrained in step 250) and the new AI model.

In step 260, the new AI model and current AI model may provide their predictions performance based on the updated test dataset, and in step 265, the computer program may compare the predictions performance from the two models.

In step 270, the computer program may select the model that has the best performance. In one embodiment, the performance may be measured based on standard metrics that may be computed for the models using the updated test dataset. Examples of metrics may include accuracy, area under receiver operating characteristics (ROC) curve, F1-Score, etc.

In one embodiment, the new AI model may be selected over the current AI model if the new AI model outperforms the current AI model such that the gain provided by the new AI model over the previous one exceeds a performance threshold. The performance threshold may be based on a cost to replace the current AI model, which may vary. The cost may be based, for example, on the engineering efforts done to replace the current AI model.

In step 275, the computer program may replace the current AI model with the selected model. The deployed pipeline will produce the predictions based on the new AI model.

Otherwise, if the new AI model outperforms the current AI model but the difference is very small, or the new AI model does not outperform the current AI model, then it may not worth replacing the current AI model with the new AI model given the cost of replacement.

In step 280, the computer program may take one more corrective actions. For example, embodiments may keep the current AI model and collect additional labels from the SMEs and retrain/retest the current AI model. In another embodiment, embodiments may conduct retraining with a different model type and/or structure. Any other suitable corrective actions may be taken as is necessary and/or desired.

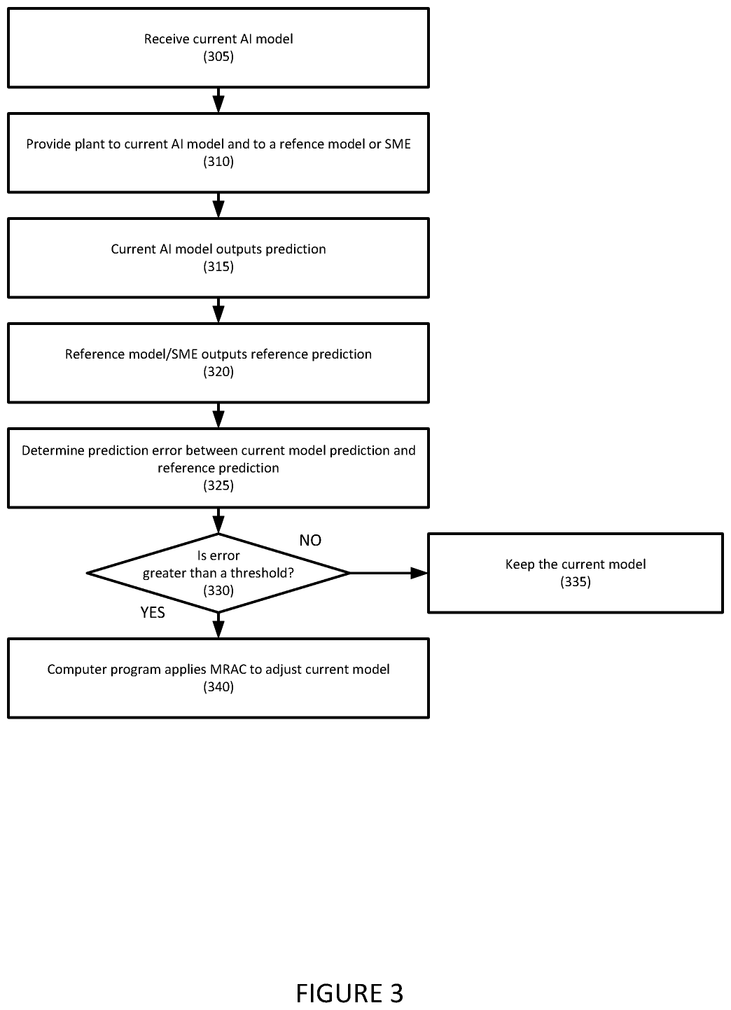

Referring to FIG. 3, a method for learning system approach using model reference adaptive control is disclosed according to an embodiment.

In step 305, a computer program, such as an AI model retraining computer program, may receive a current AI model.

In embodiments, the process may occur in the minimum viable product phase and/or the operational (production) phase.

In step 310, the computer program may provide input data from a plant, such as a system to be monitored, to the current AI model and to a reference model or SMEs. The “reference model” may be the predictions of the SMEs; thus, embodiments are directed to having the AI model mimic the SMEs using MRAC methodology.

In step 315, the current AI model may output its predictions, and in step 320, the reference model or SMEs may output reference predictions. The reference prediction may be a binary label signal generated by SME feedback that indicates whether the plant (e.g., the host) is healthy or not given the plant's data. In one embodiment, the output may be a binary classification (e.g., healthy (1) or unhealthy (0)). In another embodiment, for multi-class classification scenarios, the output may be a class label (0, 1, 2, . . . . N) predicted by SMEs based on the input data. In another embodiment, for regression problem scenarios, the output may be a real-value predicted by SMEs based on the input data.

In step 325, the computer program may determine a prediction error between the current AI model's prediction and the reference prediction. The error may represent a measure of the discrepancy between the model's predictions and ground-truth labels provided by SMEs. The error be calculated in different ways. For example, in a classification problem, the error may be based on the number of times the prediction and the SME label do not match divided by total number of predictions. For regression problems, the error may be the mean squared error (MSE). Other methods for calculating the error may be used as is necessary and/or desired.

In step 330, if the error is not greater than a threshold, in step 335, the current AI model may be kept.

If the error is greater than a threshold, in step 340, the computer program may apply MRAC techniques to adjust the current AI model. For example, the computer program may apply an automated adjustment mechanism technique to efficient and mathematically achieve convergence of the prediction error over time. For example, embodiments may apply MRAC techniques including parameter adaptation, model identification, adaptive laws, adaptive gain scheduling, robust control techniques, and/or online learning algorithms to adjust the current AI model.

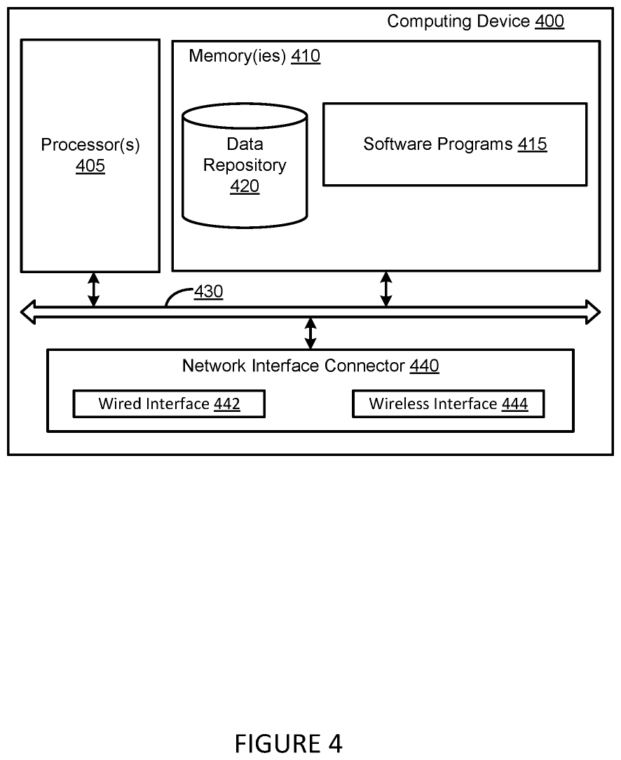

FIG. 4 depicts an exemplary computing system for implementing aspects of the present disclosure. FIG. 4 depicts exemplary computing device 400. Computing device 400 may represent the system components described herein. Computing device 400 may include processor 405 that may be coupled to memory 410. Memory 410 may include volatile memory. Processor 405 may execute computer-executable program code stored in memory 410, such as software programs 415. Software programs 415 may include one or more of the logical steps disclosed herein as a programmatic instruction, which may be executed by processor 405. Memory 410 may also include data repository 420, which may be nonvolatile memory for data persistence. Processor 405 and memory 410 may be coupled by bus 430. Bus 430 may also be coupled to one or more network interface connectors 440, such as wired network interface 442 or wireless network interface 444. Computing device 400 may also have user interface components, such as a screen for displaying graphical user interfaces and receiving input from the user, a mouse, a keyboard and/or other input/output components (not shown).

Hereinafter, general aspects of implementation of the systems and methods of embodiments will be described.

Embodiments of the system or portions of the system may be in the form of a “processing machine,” such as a general-purpose computer, for example. As used herein, the term “processing machine” is to be understood to include at least one processor that uses at least one memory. The at least one memory stores a set of instructions. The instructions may be either permanently or temporarily stored in the memory or memories of the processing machine. The processor executes the instructions that are stored in the memory or memories in order to process data. The set of instructions may include various instructions that perform a particular task or tasks, such as those tasks described above. Such a set of instructions for performing a particular task may be characterized as a program, software program, or simply software.

In one embodiment, the processing machine may be a specialized processor.

In one embodiment, the processing machine may be a cloud-based processing machine, a physical processing machine, or combinations thereof.

As noted above, the processing machine executes the instructions that are stored in the memory or memories to process data. This processing of data may be in response to commands by a user or users of the processing machine, in response to previous processing, in response to a request by another processing machine and/or any other input, for example.

As noted above, the processing machine used to implement embodiments may be a general-purpose computer. However, the processing machine described above may also utilize any of a wide variety of other technologies including a special purpose computer, a computer system including, for example, a microcomputer, mini-computer or mainframe, a programmed microprocessor, a micro-controller, a peripheral integrated circuit element, a CSIC (Customer Specific Integrated Circuit) or ASIC (Application Specific Integrated Circuit) or other integrated circuit, a logic circuit, a digital signal processor, a programmable logic device such as a FPGA (Field-Programmable Gate Array), PLD (Programmable Logic Device), PLA (Programmable Logic Array), or PAL (Programmable Array Logic), or any other device or arrangement of devices that is capable of implementing the steps of the processes disclosed herein.

The processing machine used to implement embodiments may utilize a suitable operating system.

It is appreciated that in order to practice the method of the embodiments as described above, it is not necessary that the processors and/or the memories of the processing machine be physically located in the same geographical place. That is, each of the processors and the memories used by the processing machine may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing, as described above, is performed by various components and various memories. However, it is appreciated that the processing performed by two distinct components as described above, in accordance with a further embodiment, may be performed by a single component. Further, the processing performed by one distinct component as described above may be performed by two distinct components.

In a similar manner, the memory storage performed by two distinct memory portions as described above, in accordance with a further embodiment, may be performed by a single memory portion. Further, the memory storage performed by one distinct memory portion as described above may be performed by two memory portions.

Further, various technologies may be used to provide communication between the various processors and/or memories, as well as to allow the processors and/or the memories to communicate with any other entity; i.e., so as to obtain further instructions or to access and use remote memory stores, for example. Such technologies used to provide such communication might include a network, the Internet, Intranet, Extranet, a LAN, an Ethernet, wireless communication via cell tower or satellite, or any client server system that provides communication, for example. Such communications technologies may use any suitable protocol such as TCP/IP, UDP, or OSI, for example.

As described above, a set of instructions may be used in the processing of embodiments. The set of instructions may be in the form of a program or software. The software may be in the form of system software or application software, for example. The software might also be in the form of a collection of separate programs, a program module within a larger program, or a portion of a program module, for example. The software used might also include modular programming in the form of object-oriented programming. The software tells the processing machine what to do with the data being processed.

Further, it is appreciated that the instructions or set of instructions used in the implementation and operation of embodiments may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various embodiments. Also, the instructions and/or data used in the practice of embodiments may utilize any compression or encryption technique or algorithm, as may be desired. An encryption module might be used to encrypt data. Further, files or other data may be decrypted using a suitable decryption module, for example.

As described above, the embodiments may illustratively be embodied in the form of a processing machine, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in embodiments may take on any of a variety of physical forms or transmissions, for example. Illustratively, the medium may be in the form of a compact disc, a DVD, an integrated circuit, a hard disk, a floppy disk, an optical disc, a magnetic tape, a RAM, a ROM, a PROM, an EPROM, a wire, a cable, a fiber, a communications channel, a satellite transmission, a memory card, a SIM card, or other remote transmission, as well as any other medium or source of data that may be read by the processors.

Further, the memory or memories used in the processing machine that implements embodiments may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the systems and methods, a variety of “user interfaces” may be utilized to allow a user to interface with the processing machine or machines that are used to implement embodiments. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, keypad, voice reader, voice recognizer, dialogue screen, menu box, list, checkbox, toggle switch, a pushbutton or any other device that allows a user to receive information regarding the operation of the processing machine as it processes a set of instructions and/or provides the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some embodiments of the system and method, it is not necessary that a human user actually interact with a user interface used by the processing machine. Rather, it is also contemplated that the user interface might interact, i.e., convey and receive information, with another processing machine, rather than a human user. Accordingly, the other processing machine might be characterized as a user. Further, it is contemplated that a user interface utilized in the system and method may interact partially with another processing machine or processing machines, while also interacting partially with a human user.

It will be readily understood by those persons skilled in the art that embodiments are susceptible to broad utility and application. Many embodiments and adaptations of the present invention other than those herein described, as well as many variations, modifications and equivalent arrangements, will be apparent from or reasonably suggested by the foregoing description thereof, without departing from the substance or scope. Accordingly, while the embodiments of the present invention have been described here in detail in relation to its exemplary embodiments, it is to be understood that this disclosure is only illustrative and exemplary of the present invention and is made to provide an enabling disclosure of the invention. Accordingly, the foregoing disclosure is not intended to be construed or to limit the present invention or otherwise to exclude any other such embodiments, adaptations, variations, modifications or equivalent arrangements.

What is claimed is:

1. A method, comprising:
receiving, by a computer program executed by an electronic device, a current artificial intelligence (AI) model;
providing, by the computer program, input data from a plant to the current AI model;
receiving, by the computer program, current AI model predictions from the current AI model;
receiving, by the computer program and from a subject matter expert electronic device, feedback-based labels for the current AI model predictions;
determining, by the computer program, a prediction error between the current AI model predictions and the feedback-based label;
generating, by the computer program, an updated training dataset in response to the prediction error being greater than a threshold;
training, by the computer program, the current AI model with the updated training dataset, resulting in a new AI model;
providing, by the computer program, the new AI model and the current AI model with an updated test dataset;
receiving, by the computer program, new AI model predictions from the new AI model and current AI model predictions from the current AI model;
selecting, by the computer program, the new AI model or the current AI model based on the new AI model predictions and the current AI model predictions; and
deploying, by the computer program, the new AI model or the current AI model based on the selection.

2. The method of claim 1, wherein the step of selecting, by the computer program, the new AI model or the current AI model based on the new AI model predictions and the current AI model predictions comprises:
determining, by the computer program, a new AI model performance for the new AI model and a current AI model performance for the current AI model; and
determining, by the computer program, a performance difference between the new AI model performance and the current AI model performance;
wherein the new AI model is selected in response to the performance difference being greater than a performance threshold.

3. The method of claim 2, wherein the new AI model performance and the current AI model performance are measured using at least one of accuracy, an area under receiver operating curve, and a F1-score.

4. The method of claim 2, wherein the performance threshold is based on a cost to replace the current AI model.

5. The method of claim 1, wherein the feedback-based labels for the current AI model predictions are received as a correct prediction or an incorrect prediction.

6. The method of claim 5, wherein the prediction error is based on a number of predictions that received a correct prediction feedback, and a number of predictions that receive an incorrect prediction feedback.

7. The method of claim 1, wherein the updated training dataset comprises the training dataset with the feedback-based labels and a second labeled dataset.

8. The method of claim 1, wherein the step of deploying, by the computer program, the new AI model or the current AI model based on the selection comprises:
executing, by the computer program, a corrective action in response to the current AI model being selected.

9. The method of claim 8, wherein the corrective action comprises:
collecting, by the computer program, additional feedback; and
retraining, by the computer program, the current AI model using the additional feedback.

10. A method, comprising:
receiving, by a computer program executed by an electronic device, a current artificial intelligence (AI) model;
providing, by the computer program, input data from a plant to the current AI model;
receiving, by the computer program, current AI model predictions from the current AI model;
receiving, by the computer program and from subject matter expert electronic device, feedback-based labels for the current AI model predictions;
determining, by the computer program, a prediction error between the current AI model predictions and the feedback-based label; and
applying, by the computer program, a model reference adaptive control algorithm to the current AI model in response to the prediction error being greater than a threshold.

11. The method of claim 10, wherein the feedback-based labels for the current AI model predictions are received as a correct prediction or an incorrect prediction.

12. The method of claim 11, wherein the prediction error is based on a number of predictions that received a correct prediction feedback, and a number of predictions that receive an incorrect prediction feedback.

13. The method of claim 10, wherein the model reference adaptive control algorithm comprises at least one of a parameter adaptation algorithm, a model identification algorithm, an adaptive law algorithm, an adaptive gain scheduling algorithm, a robust control technique, and an online learning algorithm.

14. The method of claim 10, further comprising:
dynamically tuning, by the computer program, the current AI model after the application of the model reference adaptive control algorithm using one or more of reinforcement learning, an evolutionary algorithm, meta-learning, online learning, Bayesian optimization, transfer learning, adversarial training, and automated machine learning.

15. A non-transitory computer readable storage medium, including instructions stored thereon, which when read and executed by one or more computer processors, cause the one or more computer processors to perform steps comprising:
receiving a current artificial intelligence (AI) model;
providing input data from a plant to the current AI model;
receiving current AI model predictions from the current AI model;
receiving, from subject matter expert electronic device, feedback-based labels for the current AI model predictions;
determining a prediction error between the current AI model predictions and the feedback-based label;
generating an updated training dataset in response to the prediction error being greater than a threshold;
training the current AI model with the updated training dataset, resulting in a new AI model;
providing the new AI model and the current AI model with an updated test dataset;
receiving new AI model predictions from the new AI model and current AI model predictions from the current AI model;
selecting the new AI model or the current AI model based on the new AI model predictions and the current AI model predictions; and
deploying the new AI model or the current AI model based on the selection.

16. The non-transitory computer readable storage medium of claim 15, wherein the new AI model or the current AI model is selected by:
determining a new AI model performance for the new AI model and a current AI model performance for the current AI model; and
determining a performance difference between the new AI model performance and the current AI model performance;
wherein the new AI model is selected in response to the performance difference being greater than a performance threshold.

17. The non-transitory computer readable storage medium of claim 16, wherein the new AI model performance and the current AI model performance are measured using at least one of accuracy, an area under receiver operating curve, and a F1-score, and the performance threshold is based on a cost to replace the current AI model.

18. The non-transitory computer readable storage medium of claim 15, wherein the feedback-based labels for the current AI model predictions are received as a correct prediction or an incorrect prediction, and the prediction error is based on a number of predictions that received a correct prediction feedback, and a number of predictions that receive an incorrect prediction feedback.

19. The non-transitory computer readable storage medium of claim 15, wherein the updated training dataset comprises the training dataset with the feedback-based labels and a second labeled dataset.

20. The non-transitory computer readable storage medium of claim 15, further including instructions stored thereon, which when read and executed by one or more computer processors, cause the one or more computer processors to execute a corrective action in response to the current AI model being selected by:
collecting additional feedback; and
retraining the current AI model using the additional feedback.
